(19) United States
(12) Patent Application Publication
(10) Pub. No.: US 2014/0173178 A1
(43) Pub. Date: Jun. 19, 2014

(54) Joint Logical and Physical Address Remapping in Non-volatile Memory

(71) Applicant: APPLE INC., Cupertino, CA (US)

(72) Inventor: Yair Schwartz, Yokneam Ilit (IL)

(73) Assignee: APPLE INC., Cupertino, CA (US)

(21) Appl. No.: 13/720,024

(22) Filed: Dec. 19, 2012

(51) Int. Cl. G06F 12/02

(52) U.S. Cl. CPC G06F 12/0246
USPC 711/103

(57) ABSTRACT

A method includes, for data items that are to be stored in a non-volatile memory in accordance with respective logical addresses, associating the logical addresses with respective physical storage locations in the non-volatile memory, and storing the data items in the respective associated physical storage locations. A remapping command, which specifies a group of source logical addresses that are associated with respective source physical storage locations, is received. In response to the remapping command, destination physical storage locations and destination logical addresses are selected jointly for replacing the source physical storage locations and the source logical addresses, respectively, so as to meet a joint performance criterion with respect to the logical addresses and the physical storage locations. The data items are copied from the source physical storage locations to the respective destination physical storage locations, and the destination physical storage locations are re-associated with the respective destination logical addresses.

### FIELD OF THE INVENTION

The present invention relates generally to data storage, and particularly to methods and systems for data storage management in non-volatile memory.

### BACKGROUND OF THE INVENTION

Various types of data storage systems use logical-to-physical address translation. In such systems, data is provided for storage in specified logical addresses, and the logical addresses are translated into respective physical addresses in which the data is physically stored. Address translation schemes of this sort are used, for example, in Flash Translation Layers (FTL) that manage data storage in Flash memory.

### SUMMARY OF THE INVENTION

An embodiment of the present invention that is described herein provides a method including, for data items that are to be stored in a non-volatile memory in accordance with respective logical addresses, associating the logical addresses with respective physical storage locations in the non-volatile memory, and storing the data items in the respective associated physical storage locations. A remapping command, which specifies a group of source logical addresses that are associated with respective source physical storage locations, is received. In response to the remapping command, destination physical storage locations and destination logical addresses are selected jointly for replacing the source physical storage locations and the source logical addresses, respectively, so as to meet a joint performance criterion with respect to the logical addresses and the physical storage locations. The data items are copied from the source physical storage locations to the respective destination physical storage locations, and the destination physical storage locations are re-associated with the respective destination logical addresses.

In some embodiments, jointly selecting the destination physical storage locations and the destination logical addresses includes reducing a first number of logical memory fragments occupied by the destination logical addresses relative to the source logical addresses, and reducing a second number of physical memory fragments occupied by the destination physical storage locations, relative to the source physical storage locations.

In an embodiment, jointly selecting the destination physical storage locations and the destination logical addresses includes increasing a throughput of accessing the data items in the non-volatile memory. In another embodiment, jointly selecting the destination physical storage locations and the destination logical addresses includes reducing a latency of accessing the data items in the non-volatile memory.

In a disclosed embodiment, jointly selecting the destination physical storage locations and the destination logical addresses includes selecting the destination logical addresses in a first contiguous sequence, and selecting the respective destination physical storage locations in a second contiguous sequence. In an alternative embodiment, the non-volatile memory includes multiple memory units, and jointly selecting the destination physical storage locations and the destination logical addresses includes selecting the destination logical addresses in a contiguous sequence, and selecting the respective destination physical storage locations in cyclical alternation among the multiple memory units.

In yet another embodiment, jointly selecting the destination physical storage locations and the destination logical addresses includes increasing a compressibility of a data structure used for storing respective associations between the logical addresses and the physical storage locations. In still another embodiment, receiving the remapping command includes receiving an indication of the destination logical addresses in the command.

In some embodiments, the remapping command does not indicate the destination logical addresses, and jointly selecting the destination physical storage locations and the destination logical addresses includes deciding the destination logical addresses in response to receiving the command. The method may include outputting a notification of the decided destination logical addresses. In an embodiment, jointly selecting the destination physical storage locations and the destination logical addresses includes identifying an idle time period, and choosing the destination physical storage locations and the destination logical addresses during the idle time period.

There is additionally provided, in accordance with an embodiment of the present invention, apparatus including an interface and a processor. The interface is configured for communicating with a non-volatile memory. The processor is configured, for data items that are to be stored in the non-volatile memory in accordance with respective logical addresses, to associate the logical addresses with respective physical storage locations in the non-volatile memory and to store the data items in the respective associated physical storage locations, to receive a remapping command, which specifies a group of source logical addresses that are associated with respective source physical storage locations, to jointly select, in response to the remapping command, destination physical storage locations and destination logical addresses for replacing the source physical storage locations and the source logical addresses, respectively, so as to meet a joint performance criterion with respect to the logical addresses and the physical storage locations, to copy the data items from the source physical storage locations to the respective destination physical storage locations, and to re-associate the destination physical storage locations with the respective destination logical addresses.

The present invention will be more fully understood from the following detailed description of the embodiments thereof, taken together with the drawings in which:

### BRIEF DESCRIPTION OF THE DRAWINGS

FIG. 1 is a block diagram that schematically illustrates a memory system, in accordance with an embodiment of the present invention;

FIG. 2 is a diagram that schematically illustrates a joint logical and physical address remapping process, in accordance with an embodiment of the present invention; and

FIG. 3 is a flow chart that schematically illustrates a method for joint logical and physical address remapping, in accordance with an embodiment of the present invention.

### DETAILED DESCRIPTION OF EMBODIMENTS

### Overview

Embodiments of the present invention that are described herein provide methods and systems for arranging the logical and physical addresses of data stored in a non-volatile memory, in order to improve storage performance and simplify storage management tasks and data structures.

Consider, for example, an embodiment in which a host stores files in a Solid State Drive (SSD) or other non-volatile memory. The host and storage device use a logical addressing scheme, and the SSD translates between logical addresses and corresponding physical addresses. The terms “physical addresses” and “physical storage locations” are used interchangeably herein.

Over time, the logical addresses used for storing the data of a given file may become fragmented, i.e., non-contiguous and often scattered in multiple fragments across the logical address space. Fragmentation of the logical addresses may develop, for example, when changes are applied to the file after it is initially created. In addition to the logical address fragmentation, the physical addresses in which the data of the file is stored in the non-volatile memory may also become fragmented. Physical address fragmentation may develop, for example, because of block compaction (“garbage collection”) and other storage management processes performed in the non-volatile memory.

Thus, over time, a given file often becomes fragmented both in the logical address space and in the physical address space. Fragmentation in the two domains (logical and physical) is often uncorrelated and caused by different reasons. Both types of fragmentation, however, are undesirable and degrade the overall storage performance.

In some embodiments that are described herein, the storage device carries out a joint address remapping operation that reduces the fragmentation of a given file in both the logical and the physical address spaces. The joint de-fragmentation process replaces both the logical addresses and the corresponding physical addresses of the file with new addresses, so as to meet a performance criterion defined over both the logical address space and the physical address space.

It is possible in principle to de-fragment the logical addresses and the physical addresses separately. Such a solution, however, will usually be sub-optimal and sometimes detrimental to the storage device performance. De-fragmenting the logical addresses without considering the corresponding physical addresses is likely to worsen the physical address fragmentation, and vice versa.

Several examples of joint remapping schemes, and joint performance criteria that are met by these schemes, are described herein. In comparison with the naïve solution of independent logical and physical de-fragmentation, the disclosed techniques are able to achieve superior storage throughput and latency, as well as reduced overhead and increased lifetime of the non-volatile memory.

Moreover, the disclosed techniques reduce the size and complexity of the data structures used for storing the logical-to-physical translation, as well as the data structures used by the host file system. Furthermore, the joint remapping operation is performed internally to the storage device without a need to transfer data between the storage device and the host. Therefore, communication load over the interface between the host and the storage device, as well as loading of host resources, are reduced.

### System Description

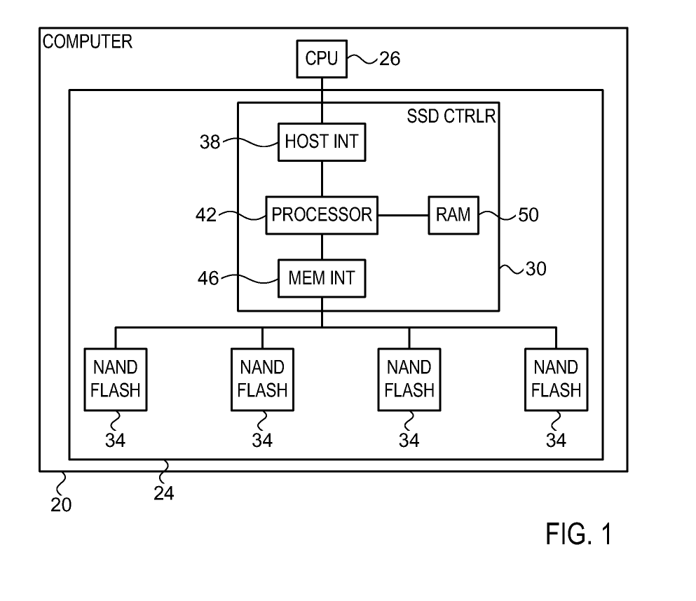

FIG. 1 is a block diagram that schematically illustrates a memory system, in accordance with an embodiment of the present invention. In the present example, the memory system comprises a computer 20 that stores data in a Solid state Drive (SSD) 24. Computer 20 may comprise, for example, a mobile, tablet or personal computer. The computer comprises a Central Processing Unit (CPU) 26 that serves as a host.

In alternative embodiments, the host may comprise any other suitable processor or controller, and the storage device may comprise any other suitable device. For example, the host may comprise a storage controller of an enterprise storage system, and the storage device may comprise an SSD or an array of SSDs. Other examples of hosts that store data in non-volatile storage devices comprise mobile phones, digital cameras, media players and removable memory cards or devices.

SSD 24 stores data for CPU 26 in a non-volatile memory, in the present example in one or more NAND Flash memory devices 34. In alternative embodiments, the non-volatile memory in SSD 24 may comprise any other suitable type of non-volatile memory, such as, for example, NOR Flash, Charge Trap Flash (CTF), Phase Change RAM (PRAM), Magnetoresistive RAM (MRAM) or Ferroelectric RAM (FeRAM).

An SSD controller 30 performs the various storage and management tasks of the SSD. The SSD controller is also referred to generally as a memory controller. SSD controller 30 comprises a host interface 38 for communicating with CPU 26, a memory interface 46 for communicating with Flash devices 34, and a processor 42 that carries out the various processing tasks of the SSD.

SSD 24 further comprises a volatile memory, in the present example a Random Access Memory (RAM) 50. In the embodiment of FIG. 1 RAM 50 is shown as part of SSD controller 30, although the RAM may alternatively be separate from the SSD controller. RAM 50 may comprise, for example a Static RAM (SRAM), a Dynamic RAM (DRAM), a combination of the two RAM types, or any other suitable type of volatile memory.

SSD controller 30, and in particular processor 42, may be implemented in hardware. Alternatively, the SSD controller may comprise a microprocessor that runs suitable software, or a combination of hardware and software elements.

The configuration of FIG. 1 is an exemplary configuration, which is shown purely for the sake of conceptual clarity. Any other suitable SSD or other memory system configuration can also be used. Elements that are not necessary for understanding the principles of the present invention, such as various interfaces, addressing circuits, timing and sequencing circuits and debugging circuits, have been omitted from the figure for clarity. In some applications, e.g., non-SSD applications, the functions of SSD controller 30 are carried out by a suitable memory controller.

In the exemplary system configuration shown in FIG. 1, memory devices 34 and SSD controller 30 are implemented as separate Integrated Circuits (ICs). In alternative embodiments, however, the memory devices and the SSD controller may be integrated on separate semiconductor dies in a single Multi-Chip Package (MCP) or System on Chip (SoC), and may be interconnected by an internal bus. Further alternatively, some or all of the SSD controller circuitry may reside on the same die on which one or more of memory devices 34 are disposed. Further alternatively, some or all of the functionality of SSD controller 30 can be implemented in software and carried out by CPU 26 or other processor in the computer. In some embodiments, CPU 26 and SSD controller 30 may be fabricated on the same die, or on separate dies in the same device package.

In some embodiments, processor 42 comprises a general-purpose processor, which is programmed in software to carry out the functions described herein. The software may be downloaded to the processor in electronic form, over a network, for example, or it may, alternatively or additionally, be provided and/or stored on non-transitory tangible media, such as magnetic, optical, or electronic memory.

CPU 26 of computer 20 typically runs a File System (FS—not shown in the figure), which stores one or more files in SSD 24. The FS stores the files in the SSD using a logical addressing scheme. In such a scheme, the FS assigns each file a group of one or more logical addresses (also referred to as Logical Block Addresses—LBAs), and sends the file data to SSD 24 for storage in accordance with the LBAs.

Processor 42 of SSD controller 30 typically maintains a logical-to-physical address translation, which associates the logical addresses specified by the host with respective physical storage locations (also referred to as physical addresses) in Flash devices 34, and stores the data in the appropriate physical storage locations. The logical-to-physical address translation (also referred to as Virtual-to-Physical mapping—V2P) may be stored in RAM 50, in Flash devices 34, or in both.

### Joint Remapping of Logical and Physical Addresses

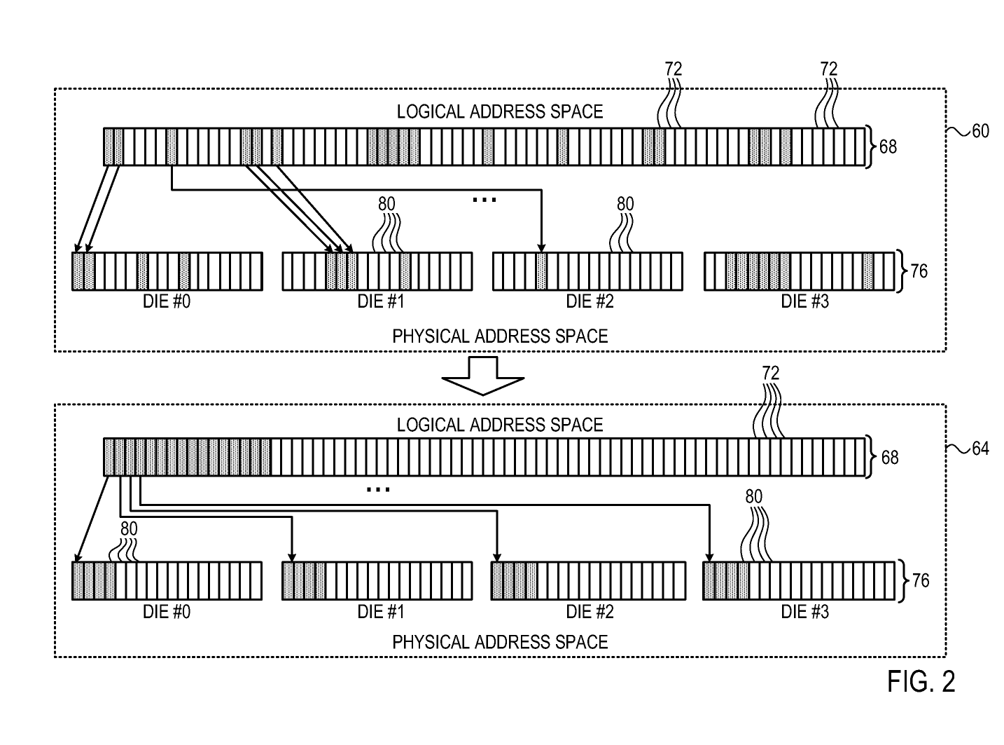

FIG. 2 is a diagram that schematically illustrates a joint logical and physical address remapping process, in accordance with an embodiment of the present invention. The top of the figure shows an association (mapping) 60 of logical addresses 72 with corresponding physical addresses 80, before applying joint address remapping. The bottom of the figure shows an improved association (mapping) 64, which is produced by the disclosed joint remapping operation. In the figure, shaded logical and physical addresses denote mark the data of a particular file of the host FS, and arrows connect the logical addresses to the respective associated physical addresses.

In the present example, each logical address 72 corresponds to a respective logical page in a logical address space 68. Each physical address 80 corresponds to a respective physical page in a physical address space 76 of Flash devices 34. In the example of FIG. 2, the physical address space spans four Flash dies denoted Die#0 . . . Die#3. In alternative embodiments, the logical-to-physical address mapping may be defined using any other suitable mapping unit, e.g., block or sector, and the logical and physical address spaces may have any other suitable configuration.

Consider mapping 60 at the top of FIG. 2. In this example, logical addresses 72 of the file in question are severely fragmented across logical address space 68. At the same time, physical addresses 80 of the file are severely fragmented across physical address space 76.

At some point in time, processor 42 of SSD controller 30 receives from CPU 26 a remapping command. In response to the command, processor 42 jointly remaps the logical and physical addresses of the file, so as to produce mapping 64 at the bottom of the figure. (In a typical Flash memory, data cannot be overwritten in-place, and therefore the new physical addresses of the data will typically reside in new memory blocks. This feature is not shown in FIG. 2 for the sake of clarity.)

As can be seen in the figure, both the logical addresses and the physical addresses of the file are considerably less fragmented in mapping 64 in comparison with mapping 60. The remapping operation considers fragmentation in the logical address space and in the physical address space jointly, rather than trying to de-fragment each address space separately from the other.

In the present context, the logical and physical addresses of the file in mapping 60 (before remapping) are referred to as source logical and physical addresses, respectively. The logical and physical addresses of the file in mapping 64 (after remapping) are referred to as destination logical and physical addresses, respectively. The remapping operation thus selects the destination logical and physical addresses for replacing the source logical and physical addresses of the file.

Processor 42 typically remaps the source logical and physical addresses so as to meet a certain performance criterion that is defined over both the logical and physical domains, i.e., over both the logical and physical addresses. In various embodiments, processor 42 may use different performance criteria for selecting the destination logical and physical addresses for the remapping operation.

In one example embodiment, the remapping is performed so as to reduce or minimize the amount of fragmentation in the two domains. In other words, processor 42 selects the destination logical and physical addresses so as to reduce the number of fragments of logical address space 68 in which the file data is stored, and at the same time to reduce the number of fragments of physical address space 76 in which the file data is stored.

In another embodiment, processor 42 selects the remapping operation so as to maximize the storage (write and/or read) throughput of SSD 30. Such a criterion typically depends on the structure of the SSD. The remapping operation of FIG. 2, for example, is suitable for an SSD that supports multi-die read and write commands, which read and write multiple corresponding pages in multiple respective dies in parallel. In order to best utilize these commands mapping 64 maps successive logical addresses 72 are mapped to physical addresses that alternate cyclically among the four dies. A similar alternation can be applied among other types of physical memory units, such as memory devices, memory planes or even memory blocks. In yet another embodiment, processor 42 configures the remapping operation so as to minimize the storage (write and/or read) latency of SSD 24.

In other embodiments, the remapping operation is chosen so as to reduce the size and/or complexity of a data structure in the host or in the storage device. For example, the remapping may be selected so as to make the V2P mapping of the SSD as compressible as possible. High compressibility is typically achieved by reducing fragmentation, but may also depend on the specific configuration of the data structure used for storing the V2P mapping. As another example, the remapping may be selected so as to simplify the data structure used for storing the mapping of files to LBAs in the host.

Further alternatively, processor 42 may remap the logical and physical addresses so as to meet any other suitable performance criterion.

As explained above, the remapping command is typically sent from CPU 26 (or more generally from the host) to processor 42 (or more generally to the storage device). The command typically indicates the group of source logical addresses of the file that is to be remapped. In some embodiments, the destination logical addresses are selected by the host FS. In such an implementation the destination logical addresses are specified in the remapping command in addition to the source logical addresses.

In alternative embodiments, the command specifies only the source logical addresses, and the storage device (e.g., processor 42) selects the destination logical addresses. The storage device thus notifies the host of the selected destination logical addresses. These embodiments are typically used when the host and storage device use trim commands, which indicate to the storage device which logical addresses are not in use by the host FS. In either case, the destination physical addresses are selected by processor 42.

### Joint Remapping Method Description

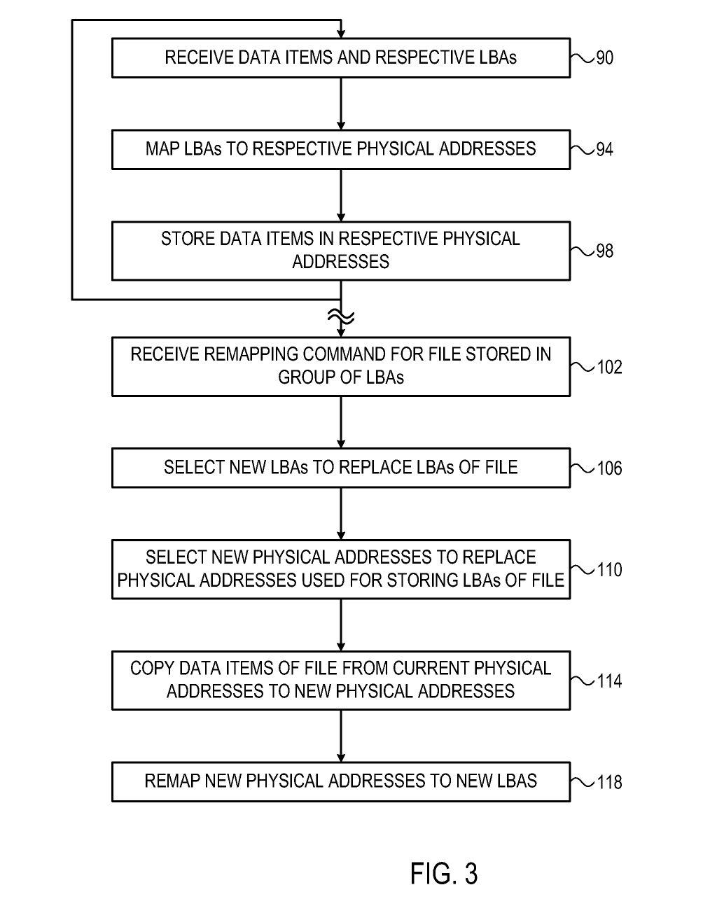

FIG. 3 is a flow chart that schematically illustrates a method for joint logical and physical address remapping, in accordance with an embodiment of the present invention. The method begins with processor 42 receiving from CPU 26 data items for storage in Flash devices 34, at an input step 90. The data items are received via interface 38 for storage in respective logical addresses.

Processor 42 associates the logical addresses of the data items with respective physical addresses, at a mapping step 94, and stores the data items in the respective physical addresses, at a storage step 98. The storage process of steps 90-98 is typically carried out whenever CPU 26 (or more generally the host) has data items to store in the SSD.

At some point in time, CPU 26 sends to SSD 24 a remapping command for a particular file, at a remapping command step 102. The remapping command indicates the group of logical addresses in which the data items of the file are stored (i.e., the source logical addresses). The source logical addresses of the file are associated (in accordance with the mapping of step 94 above) with respective source physical addresses.

In response to the remapping command, processor 42 selects destination logical addresses to replace the respective source logical addresses, at a logical remapping step 106, and selects destination physical addresses to replace the respective source physical addresses, at a physical remapping step 110. The selection of destination logical and physical addresses (steps 106 and 110) is performed jointly, so as to meet a performance criterion with respect to the logical and physical addresses.

Processor 42 copies the data items of the file from the source physical addresses to the destination physical addresses, at a copying step 114. Processor 42 associates the destination logical addresses with the corresponding destination physical addresses, at a logical re-association step 118. Typically, processor 42 updates the V-P mapping to reflect the improved mapping.

In some embodiments, processor 42 carries out the remapping operation in a background task, which is executed during idle time periods in which the processor is not busy executing storage commands. Processor 42 typically identifies such idle time periods, and carries out the remapping task during these periods. Background operation of this sort enables processor 42, for example, to copy and remap large bodies of data so as to occupy large contiguous address ranges in both the logical and physical domains.

It will be appreciated that the embodiments described above are cited by way of example, and that the present invention is not limited to what has been particularly shown and described hereinabove. Rather, the scope of the present invention includes both combinations and sub-combinations of the various features described hereinabove, as well as variations and modifications thereof which would occur to persons skilled in the art upon reading the foregoing description and which are not disclosed in the prior art. Documents incorporated by reference in the present patent application are to be considered an integral part of the application except that to the extent any terms are defined in these incorporated documents in a manner that conflicts with the definitions made explicitly or implicitly in the present specification, only the definitions in the present specification should be considered.

1. A method, comprising:
for data items that are to be stored in a non-volatile memory in accordance with respective logical addresses, associating the logical addresses with respective physical storage locations in the non-volatile memory, and storing the data items in the respective associated physical storage locations;
receiving a remapping command, which specifies a group of source logical addresses that are associated with respective source physical storage locations;
in response to the remapping command, jointly selecting destination physical storage locations and destination logical addresses for replacing the source physical storage locations and the source logical addresses, respectively, so as to meet a joint performance criterion with respect to the logical addresses and the physical storage locations; and
copying the data items from the source physical storage locations to the respective destination physical storage locations, and re-associating the destination physical storage locations with the respective destination logical addresses.

2. The method according to claim 1, wherein jointly selecting the destination physical storage locations and the destination logical addresses comprises reducing a first number of logical memory fragments occupied by the destination logical addresses relative to the source logical addresses, and reducing a second number of physical memory fragments occupied by the destination physical storage locations, relative to the source physical storage locations.

3. The method according to claim 1, wherein jointly selecting the destination physical storage locations and the destination logical addresses comprises increasing a throughput of accessing the data items in the non-volatile memory.

4. The method according to claim 1, wherein jointly selecting the destination physical storage locations and the destination logical addresses comprises reducing a latency of accessing the data items in the non-volatile memory.

5. The method according to claim 1, wherein jointly selecting the destination physical storage locations and the destination logical addresses comprises selecting the destination logical addresses in a first contiguous sequence, and selecting the respective destination physical storage locations in a second contiguous sequence.

6. The method according to claim 1, wherein the non-volatile memory comprises multiple memory units, and wherein jointly selecting the destination physical storage locations and the destination logical addresses comprises selecting the destination logical addresses in a contiguous sequence, and selecting the respective destination physical storage locations in cyclical alternation among the multiple memory units.

7. The method according to claim 1, wherein jointly selecting the destination physical storage locations and the destination logical addresses comprises increasing a compressibility of a data structure used for storing respective associations between the logical addresses and the physical storage locations.

8. The method according to claim 1, wherein receiving the remapping command comprises receiving an indication of the destination logical addresses in the command.

9. The method according to claim 1, wherein the remapping command does not indicate the destination logical addresses, and wherein jointly selecting the destination physical storage locations and the destination logical addresses comprises deciding the destination logical addresses in response to receiving the command.

10. The method according to claim 9, and comprising outputting a notification of the decided destination logical addresses.

11. The method according to claim 1, wherein jointly selecting the destination physical storage locations and the destination logical addresses comprises identifying an idle time period, and choosing the destination physical storage locations and the destination logical addresses during the idle time period.

12. Apparatus, comprising:
an interface for communicating with a non-volatile memory; and
a processor, which is configured, for data items that are to be stored in the non-volatile memory in accordance with respective logical addresses, to associate the logical addresses with respective physical storage locations in the non-volatile memory and to store the data items in the respective associated physical storage locations, to receive a remapping command, which specifies a group of source logical addresses that are associated with respective source physical storage locations, to jointly select, in response to the remapping command, destination physical storage locations and destination logical addresses for replacing the source physical storage locations and the source logical addresses, respectively, so as to meet a joint performance criterion with respect to the logical addresses and the physical storage locations, to copy the data items from the source physical storage locations to the respective destination physical storage locations, and to re-associate the destination physical storage locations with the respective destination logical addresses.

13. The apparatus according to claim 12, wherein, by jointly selecting the destination physical storage locations and the destination logical addresses, the processor is configured to reduce a first number of logical memory fragments occupied by the destination logical addresses relative to the source logical addresses, and to reduce a second number of physical memory fragments occupied by the destination physical storage locations, relative to the source physical storage locations.

14. The apparatus according to claim 12, wherein, by jointly selecting the destination physical storage locations and the destination logical addresses, the processor is configured to increase a throughput of accessing the data items in the non-volatile memory.

15. The apparatus according to claim 12, wherein, by jointly selecting the destination physical storage locations and the destination logical addresses, the processor is configured to reduce a latency of accessing the data items in the non-volatile memory.

16. The apparatus according to claim 12, wherein the processor is configured to select the destination logical addresses in a first contiguous sequence, and to select the respective destination physical storage locations in a second contiguous sequence.

17. The apparatus according to claim 12, wherein the non-volatile memory comprises multiple memory units, and wherein the processor is configured to select the destination logical addresses in a contiguous sequence, and to select the respective destination physical storage locations in cyclical alternation among the multiple memory units.

18. The apparatus according to claim 12, wherein, by jointly selecting the destination physical storage locations and the destination logical addresses, the processor is configured to increase a compressibility of a data structure used for storing respective associations between the logical addresses and the physical storage locations.

19. The apparatus according to claim 12, wherein the interface is configured to receive an indication of the destination logical addresses in the remapping command.

20. The apparatus according to claim 12, wherein the remapping command does not indicate the destination logical addresses, and wherein the interface is configured to decide the destination logical addresses in response to receiving the command.

21. The apparatus according to claim 20, wherein the processor is configured to output a notification of the decided destination logical addresses.

22. The apparatus according to claim 12, wherein the processor is configured to identify an idle time period, and to choose the destination physical storage locations and the destination logical addresses during the idle time period.
